(19) United States
(12) Patent Application Publication
(10) Pub. No.: US 2006/0280165 A1
(43) Pub. Date: Dec. 14, 2006

(54) Intelligent negotiator node

(76) Inventors: Gordon Blumenschein, Woodridge, IL (US); Walter Malinowski, Naperville, IL (US); Thomas McBlain, Arlington Heights, IL (US); Dianna Tiliks, Palatine, IL (US); Paul Vlasek, Brookfield, IL (US)

Correspondence Address: Paul Barenie, Esq., 2158 45th Street, No. 612, Highland, IN, 46322-3742, US

(21) Appl. No.: 11/152,353

(22) Filed: Jun. 14, 2005

(51) Int. Cl. H04L 12/66

(52) U.S. Cl. 370/352

(57) ABSTRACT

A system and method provide an Advanced Intelligent Network (AIN) service for a packet-based telephone subscriber using an Intelligent Negotiator Node (INN), the INN capable of communicating using a packet-based communication protocol. The INN includes an application server that receives a service request message at the INN, including information in a packet-based protocol, the information including an identification of a packet-based telephone subscriber. The application server determines an AIN service subscribed to by the packet-based telephone subscriber, and performs the AIN service. Performance of the AIN service may include using a media server of the INN to provide a voice message to a packet-based telephone subscriber during the providing of the AIN service, thereby incorporating the INN into the voice path of a telephone call. Performance of the AIN service may include the INN retrieving information from the Internet, that is used in the providing of the AIN service. Performance of the AIN service using retrieved Internet information may be accomplished for both packet-based and PSTN telephone subscribers.

### TECHNICAL FIELD

This invention is directed to an Intelligent Negotiator Node, and more particularly, to an Intelligent Negotiator Node and method for interfacing between Public Switched Telephone Network elements and packet-based telephone elements and subscribers.

### BACKGROUND ART

Public Switched Telephone Network (PSTN) subscribers are provided telephone service and Advanced Intelligent Network (AIN) services via various PSTN network elements. Such PSTN network elements include Service Switching Points (SSPs), Service Control Points (SCPs), and Intelligent Network (IN) devices, as well as the twisted wire pairs, trunked-communication lines, Signal System 7 (SS7) communication lines and Signal Transfer Points (STPs) linking the PSTN subscriber with the various PSTN elements. The AIN services provided to the PSTN subscribers may include, for example, call forwarding, caller identification, alternate routing, etc. . . . The AIN services are typically provided to the PSTN customer using AIN triggers such as an Off-Hook Trigger, Off-Hook Delay Trigger, and a Termination Attempt Trigger, such that a trigger condition interrupts the telephone call at an SSP, and generates a query to an SCP that determines and performs the AIN service(s) to which the PSTN subscriber may subscribe.

A packet-based telephone subscriber is one that is provided telephone service via packet-based communication protocols, through a packet-based device, for example, a softswitch. Examples of a packet-based telephone subscribers include subscribers receiving telephone service via the Internet, or via a private Internet Protocol (IP) based network. The softswitch interfaces with the PSTN at an IP interface point, typically associated with a tandem switch, where the IP interface point provides translations between the IP communication protocol and the signal system 7 (SS7) protocol utilized within the PSTN.

In order to provide a packet-based telephone subscriber with AIN services, the packet-based call must enter the PSTN via the IP interface point, and be transferred to an SSP. At the SSP, a determination is made as to whether an AIN trigger is associated with the packet-based telephone subscriber. If a trigger is associated with the packet-based subscriber, a query is launched to an SCP, where the AIN service(s) are determined and carried-out, for example, to determine an appropriate routing for the telephone call. However, especially where a call destination is blocked for the packet-based telephone subscriber, the providing of AIN services to a packet-based subscriber in this manner is not an efficient use of PSTN resources. The telephone call from the packet-based subscriber must enter the PSTN at the tandem switch, and consume SS7 resources and SS7 communication links via routing to the SSP, and between the SSP and the SCP, before routing instructions are received for the call.

In some circumstances, information from the Internet may be useful for providing AIN services. SCPs utilize a dedicated IN device within the PSTN Network to retrieve desired information from the Internet for use in performing an AIN service. However, communication with IN devices external to the SCP reduces SS7 resources such as SS7 signaling links that would otherwise be available for other PSTN uses or AIN services. Further, IN devices dedicated for retrieving information from the Internet deplete the limited number of available sub-system numbers (SSNs) and translation type numbers (TTNs) used to identify various IN devices within the PSTN.

This invention is directed to solving one or more of the problems discussed above.

### BRIEF DESCRIPTION OF SEVERAL VIEWS OF THE DRAWINGS

FIG. 1 is a block diagram of an Intelligent Negotiator Node in accordance with an embodiment of the invention;

FIG. 2 is a block diagram representation of an information packet of a packet-based communication protocol in accordance with an embodiment of the invention;

FIG. 3 is a block diagram of a database in a database of the Intelligent Negotiator Node in accordance with an embodiment of the invention;

FIG. 4 is a flow chart illustrating operation of the Intelligent Negotiator Node 100 in accordance with an embodiment of the invention;

FIG. 5 is a flowchart describing the receiving a service request message at the Intelligent Negotiator Node in accordance with an embodiment of the invention;

FIG. 6 is a flowchart describing operation of the Intelligent Negotiator Node in determining an AIN service in accordance with an embodiment of the invention;

FIG. 7 is a flowchart describing performing AIN service(s) at the Intelligent Negotiator Node in accordance with an embodiment of the invention;

FIG. 8 is a block diagram of an Intelligent Negotiator Node 100′ that is coupled with an Intelligent Network device that may be used in carrying-out an AIN service, in accordance with an embodiment of the invention;

FIG. 9 is a block diagram of a database that may be utilized with the Intelligent Negotiator Node 100′ of FIG. 8, in accordance with an embodiment of the invention;

FIG. 10 is a flowchart illustrating the Intelligent Negotiator Node 100′ performing an AIN service using one or more Intelligent Network devices, in accordance with an embodiment of the invention;

FIG. 11 is a block diagram of a telecommunications network that may utilize the Intelligent Negotiator Node in providing AIN services, in accordance with an embodiment of the invention;

FIG. 12 is a flowchart illustrating operation of the telecommunications network of FIG. 11 utilizing the Intelligent Negotiator Node in providing AIN services, in accordance with an embodiment of the invention;

FIG. 13 is a representation of an exemplary SIP INVITE Message, in accordance with an embodiment of the invention; and

FIG. 14 is a block diagram of a telecommunications network that may utilize the Intelligent Negotiator Node coupled with additional AIN devices in performing AIN services, in accordance with an embodiment of the invention.

### DETAILED DESCRIPTION OF THE PREFERRED EMBODIMENT

A system and method provide an Advanced Intelligent Network (AIN) service for a packet-based telephone subscriber using an Intelligent Negotiator Node (INN), the INN capable of communicating using a packet-based communication protocol. The INN includes an application server that receives a service request message at the INN, including information in a packet-based protocol, the information including an identification of a packet-based telephone subscriber. The application server determines an AIN service subscribed to by the packet-based telephone subscriber, and performs the AIN service. Performance of the AIN service may include using a media server to provide a voice message to a packet-based telephone subscriber during the providing of the AIN service, thereby incorporating the INN into the voice path of a telephone call. Performance of the AIN service may include the INN launching a request to the Internet, to retrieve information for carrying-out the AIN service.

Having the INN facilitates the integration of packet-based telephone subscribers into the Public Switched Telephone Network (PSTN) by providing packet-based telephone subscribers AIN services. As the INN has capabilities for communicating in the packet-based communication protocol, it may communicate directly with a packet-based subscriber (or a device such as a softswitch serving the packet-based subscriber), and thus provide the AIN services for the packet-based telephone subscriber. The providing AIN services may include providing any desired routing information for a packet-based telephone subscriber's call before the call enters the PSTN at a switching point. Providing an AIN service for the packet-based telephone subscriber before the call enters the PSTN at a switching point conserves valuable PSTN resources. For example, a determination as to whether the telephone call may continue and/or routing information may be determined for a telephone call, before Signal System 7 (SS7) links in transferring a call to a Service Switching Point (SSP), and/or the querying/response between the SSP and the Service Control Point (SCP), are utilized within the PSTN network. Thus, especially where the telephone call of the packet-based subscriber is to be blocked, such PSTN resources need not be consumed.

As the INN may have capabilities for providing voice messages to packet-based telephone subscribers, audible information may be provided to the packet-based telephone subscriber during the providing of an AIN service, that may be pertinent to an action taken with respect to a call in response to a particular AIN service being performed.

As the INN has capabilities for launching Internet queries, the INN may retrieve information from the Internet that may be utilized in providing AIN services to both packet-based telephone subscribers, and PSTN telephone subscribers. As the INN has capabilities for accessing the Internet for such information, IN devices that are used to retrieve information from the Internet may be unnecessary, thereby reducing PSTN resources that are required in accessing the Internet capable IN device. As the Internet IN device is not necessary, consumption of the limited number of available sub-system numbers (SSNs) and translation type numbers (TTNs) that would otherwise be required to identify the Internet IN device in the PSTN is reduced. Further, the signal routing to/from an Internet capable IN device is not necessary, thereby conserving PSTN resources.

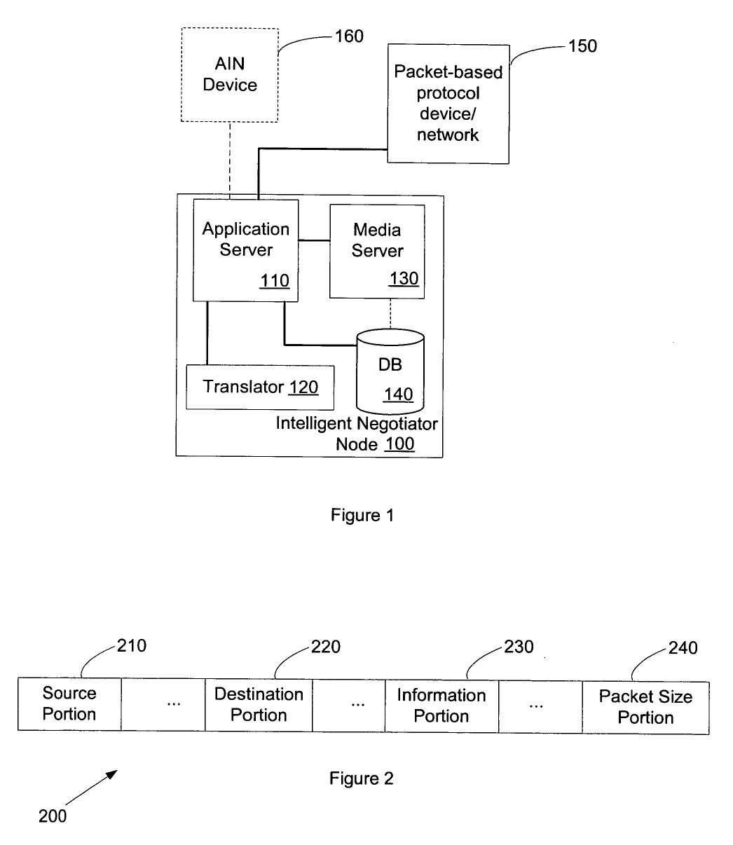

FIG. 1 is a block diagram of an Intelligent Negotiator Node in accordance with an embodiment of the invention. An Intelligent Negotiator Node (INN) 100 may include an application server 110. Application server 110 may be coupled with a translator 120, a media server 130, and a data base 140. In a further embodiment, the media server 130 may further be coupled with the database 140, as described below. The application server 110 may additionally be coupled with a packet-based protocol device/network 150.

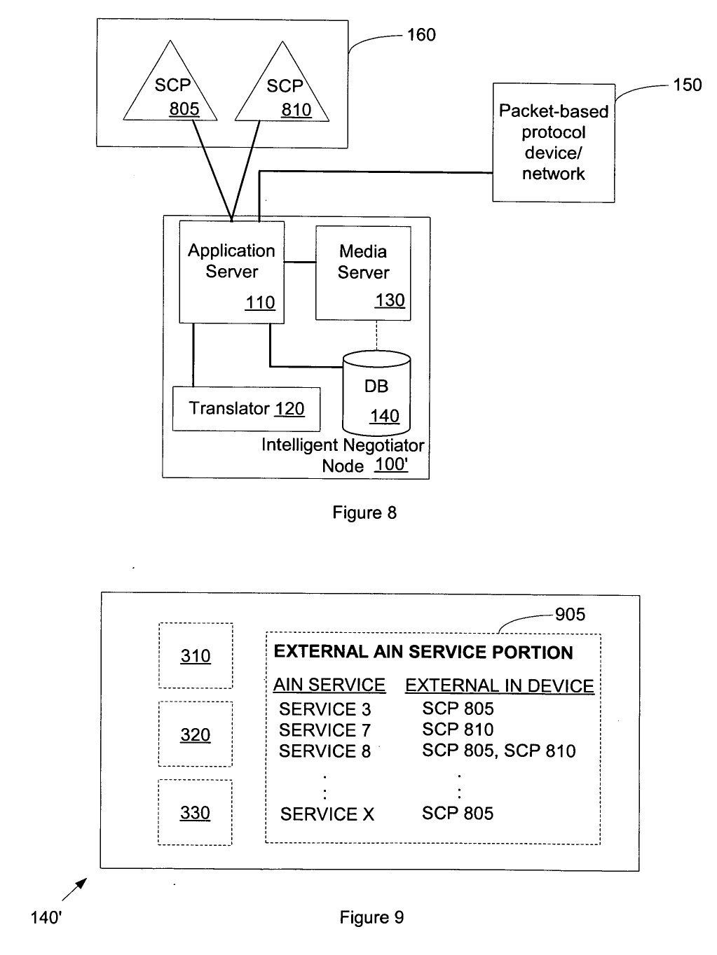

In a further embodiment discussed below with respect to FIGS. 8-10, the INN 100 may have capabilities for determining whether one or more AIN devices 160 coupled with the INN has capabilities for performing AIN services. Where an AIN device coupled with the INN 100 is determined to have capabilities for performing an AIN service, the INN 100 may direct the service request message to the AIN device(s), for example, after performing any necessary protocol translation, or may otherwise employ the AIN device 160 in carrying-out the subscribed AIN service(s) as discussed below.

The application server 110 may include, for example, a microprocessor (not shown) sufficiently programmed for carrying-out the functionality described herein. The application server 110 may further include one or more memory devices (not shown) that may be utilized, for example, for storing programming used in controlling the operation of the application server 110, and for providing temporary storage during the operation of the application server 110. The one or more memory devices may be implemented as any computer readable medium (CRM) capable of providing the short term or the long term storage of information, including but not limited to, floppy disks, conventional hard disks, any volatile or nonvolatile ROMs including PROM, EPROM, EEPROM, CD-ROM, any RAM including SRAM, DRAM, and SDRAM, any memory device derived therefrom, as well as any signals containing or otherwise including instructions that may be stored within the one or more memory devices, as will be appreciated by one skilled in the art.

The application server 110 is disclosed in detail below, and has capabilities for determining AIN services subscribed to by the telephone subscriber, for example, a packet-based telephone subscriber. Exemplary AIN services are discussed below. Such services may be determined using the database 140. The application server further has capabilities for determining an order of AIN services performed at the INN. Upon performing AIN services, the application server 110 has capabilities for generating one or more service response messages used in carrying-out an AIN service(s). Further, the application server 110 has capabilities for interfacing with a media server in providing one or more of voice announcements to the packet-based telephone subscriber, and interfacing with the translator 120 where translating between various communications protocols is desired.

The translator 120 has capabilities for translating between various communications protocols, for example, between packet-based communication protocols and AIN communication protocols. For example, the translator 120 may receive a packet-based communication protocol message, forwarded by the application server 110 from the packet-based protocol device/network 150, and determine pertinent information within the message such as an identification of the packet-based telephone subscriber, and a destination for the telephone call from the packet-based telephone subscriber. The translator 120 may then provide this information to the application server 110.

As the translator 120 is programmed to identify, and translate between various communication protocols, it is capable of identifying the communications protocol employed by the message it receives. For example, the particular communication protocol may be determined using a header of an information packet received at the INN, or may be determined based on the particular communication link over which the information packet was received at the INN. Regarding the former, it will be appreciated by one skilled in the art that the header information of a particular information packet often includes information regarding the communication protocol and version of the protocol, for the information packet. Regarding the latter, it will be appreciated by one skilled in the art that there may be some predetermined convention of communication protocol associated with the particular communication link over which the information packet is received. For example, messages received via SS7 links at the INN may be determined to be AIN messages, whereas information packets received via TCP/IP links at the INN may be determined to utilize the Session Initiation Protocol (SIP), or some other predetermined packet-based communication protocol

Upon determining the communication protocol of the message, the translator 120 knows where (i.e. in which fields or portions) in the message to find pertinent information for use by the INN 100. The pertinent information may, for example, be specifically requested by the application server 110, or all information from a particular information message packet may be retrieved automatically by the translator upon receipt of the message packet, and communicated to the application server.

FIG. 2 is a block diagram representation of an information packet 200 of a packet-based communications protocol. Such an information packet may be utilized to convey information in the SIP communication protocol, the Parlay message protocol, an Internet Protocol (IP) packet-based message, a Hypertext Transfer Protocol (HTTP), a File Transfer Protocol (FTP), an extensible Markup Language (XML) protocol, a Voice over Internet Protocol (VoIP), or any other packet-based communication protocols as will be appreciated by one skilled in the art. Information packets of a packet-based communications protocol, such as the information packet 200, are known to one skilled in the art, and may include a source portion 210, that indicates the source (address) of the information packet, and a destination portion 220 indicating a destination (address) for the information packet on the packet-based network. The information packet 200 may further include an information portion 230 that carries the information to be conveyed by the particular message packet, and may further include a packet-size portion 240 providing information as to the packet size of the information packet 200. Information 230 may include, for example, voice information in the form of analog to digital converted voice data/packets, it may include text information such as for e-mail messages or text messaging information, or it may include control data describing how a particular telephone call is to be handled, for example, a telephone call from the packet-based telephone subscriber. In addition or in the alternative, the information portion 230 may be utilized to convey any information to/from the INN 100 in providing AIN service to a packet-based telephone subscriber. The use of the information packet 200 in providing telephone service to a packet-based telephone subscriber will be described in more detail below. It will be appreciated to one skilled in the art that the information packet 200 may include other portions specific to the particular communications protocol being utilized.

Returning to FIG. 1, the media server 130 has capabilities for providing voice messages to a packet-based telephone subscriber. Such voice messages may be in response to, for example, an AIN service determined at the application server 110 for the packet-based telephone subscriber. The media server 130 may include an internal database/memory (not shown) for storing various voice messages, also commonly referred to as announcements. In the alternative, or in addition, the media server 130 may be coupled with the database 140, where the database 140 stores various voice message information as described below. The voice messages may be stored as digitized voice data. The voice messages may, for example, include voice messages that are typically stored at a SSP of the PSTN.

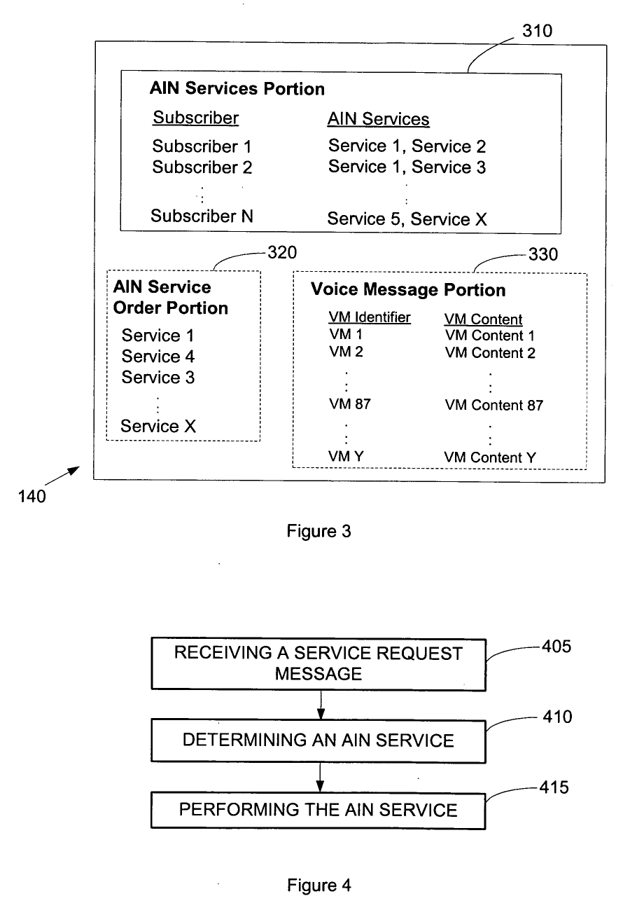

The database 140 may store various information that may be used by the INN 100 in providing AIN service to a packet-based telephone subscriber. FIG. 3 is a block diagram representation of a database 140 in accordance with an embodiment of the invention.

As shown in FIG. 3, the database 140 may include one or more of an AIN services portion 310, an AIN service order portion 320, and in another embodiment of the invention, a voice message portion 330. The AIN services portion 310 may include various services to which a telephone subscriber such as the packet-based telephone subscriber may subscribe. For example, as shown in the AIN services portion 310, the subscriber 1 is shown to subscribe to AIN service 1 and AIN service 2. The AIN service order portion 320 may include an order in which to perform AIN services that may be provided to a packet-based telephone service subscriber. For example, as shown at the service order portion 320, AIN service 1 is to be performed first, followed by AIN service 4, AIN service 3, continuing to AIN service X. The voice message portion 330 may include various voice message (VM) identifiers, for example VM identifiers 1 through Y, linked with voice messages 1 through Y that may be provided to a telephone subscriber. For example, the voice message portion 330 may include a VM identifier #87 that is linked with the corresponding VM content 87: “I'm sorry, your call is not authorized.” The voice message content may be stored as digitized voice information. As will be appreciated by one skilled in the art, the AIN services portion 310, the AIN service order portion 320 and the voice message portion 330 may be implemented as different database files resident within the database 140, or may be implemented as different portions of the same database file.

Returning to FIG. 1, the packet-based protocol device/network 150 may represent any packet-based device or network through which an AIN service may be provided to a packet-based telephone subscriber, and/or any packet-based network used during the providing of AIN service(s) to an AIN subscriber. For example, the packet-based protocol/device 150 may include a softswitch, such as a Cisco BTS or a Lucent Softswitch (LSS) utilized in providing telephone service to a packet-based telephone subscriber. In addition, or in the alternative, the packet-based protocol/device 150 may include a packet-based network such, as the Internet, for example, used in the providing of telephone and/or AIN service(s) to a packet-based telephone subscriber, or in gathering information used in providing AIN service(s) to a PSTN or packet-based telephone subscriber.

The components of the INN 100 may be communicatively coupled, for example, by Ethernet connections, using Cat 5 cable, by a common BUS, or by any other fashion allowing the various components within the INN 100 to communicate with one another, as will be appreciated by one skilled in the art.

The INN 100 may be utilized to provide AIN services for a packet-based and/or PSTN telephone subscribe. Such AIN services may include the providing of routing information for a packet-based subscriber before the telephone call enters the PSTN network at a tandem switching point. When carrying-out AIN services for either packet-based telephone subscribers, or PSTN telephone subscribers, the INN 100 utilizes preprogrammed logic, for example, within the application server 100, in a similar fashion as in a typical Service Control Point (SCP), for example, a Telcordia ISCP operating with Service Provisioning and Creation Environment (SPACE), or a Lucent SCP operating under Service Logic Language (SLL) programming. Thus, when providing AIN services for a PSTN subscriber, the INN may appear the same as any SCP to the SSP serving the PSTN telephone subscriber. However, in some circumstances, it may be desired to perform particular actions that are beyond the capabilities of an SCP. For example, it may be desirable to provide AIN services to a packet-based telephone subscriber, without the unnecessary consumption of PSTN resources. In addition, or in the alternative, it may be desirable that a voice message be provided to a packet-based telephone subscriber during the performance of the AIN service. Additionally, or in the alternative, information from the Internet may be desired for use in providing an AIN service to either a packet-based or PSTN telephone subscriber. In such cases, the INN has capabilities for providing AIN services to PSTN or packet-based telephone subscribers, including providing a voice message used in the providing of an AIN service, and for retrieving information from the Internet that may be used in providing an AIN service, as will be described in further detail below.

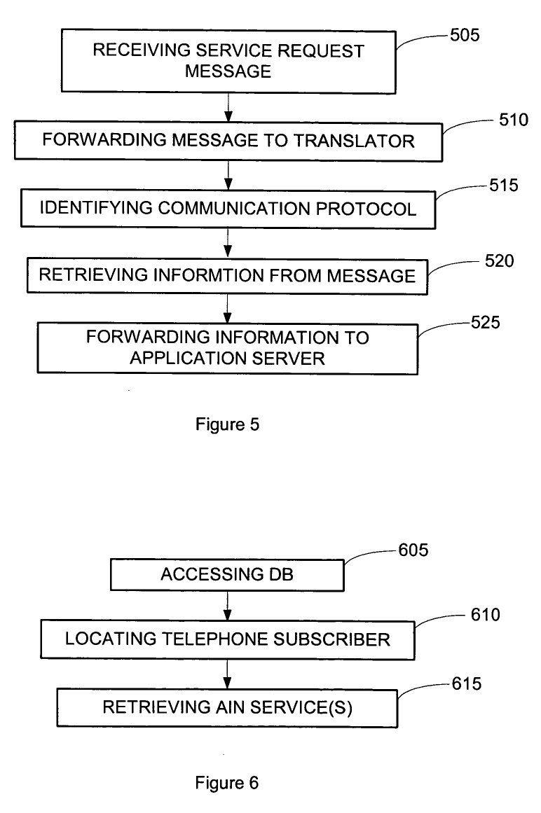

FIG. 4 is a flow chart illustrating operation of the INN 100 in accordance with an embodiment of the invention. As shown in FIG. 4, the service request message may be received 405 at the INN 100, an AIN service may be determined 410, and the AIN service may be performed 415. FIGS. 5, 6 and 7 are flowcharts describing the receiving 405, the determining 410 and the performing 415, in accordance with embodiments of the invention.

FIG. 5 is a flowchart describing the receiving 405 a service request message at the INN in accordance with an embodiment of the invention. A service request message may be received 505 at the application server 110, via a packet-based protocol device/network 150, for example, from a packet-based telephone subscriber via a softswitch (not shown) serving a packet-based telephone subscriber. The service request message may take the form of one or more information packets, for example, each of which may have the form of the information packet shown in FIG. 2.

The service request message may be forwarded 510 to the translator 120 for translation. As described above, the translator 120 has capabilities for translating between various communication protocols, for example, by identifying 515 the particular communication protocol used for the service request message. The translator may then retrieve 520 pertinent information from the packet-based service request message. The pertinent information may be, for example, specific information requested by the application server 110, or may be all information present within the service request message. Such information may include, for example, a source of the service request message, using the source portion 210 of the service request message, and a destination indicated within the destination portion 220 of the service request message. The translator 120 may then forward 525 the information, for example, the source and destination information, to the application server 110. Such reception, translation and retrieving of pertinent information may be accomplished on an on-going basis by the translator 120, where the application server 110 interleaves translation requests to the translator with other operations or functionality being performed by the application server 110, as will be appreciated by one skilled in the art.

After the service request message is received at 405, determining an AIN service 410 may be accomplished as described with respect to the flowchart of FIG. 6.

FIG. 6 is a flowchart describing operation of the INN in determining an AIN service in accordance with an embodiment of the invention. As shown in FIG. 6, the application server 110 accesses 605 the database 140, specifically, the AIN service portion 310. The telephone subscriber is then located 610 in the database 140. The corresponding AIN service(s) for the telephone subscriber is then retrieved 615 from the database 140 by the application server 110. For example, where the source information of a message packet indicates subscriber 1, the application server 110 may identify the particular subscriber within the AIN services portion 310 using the source information 210 of the service request message, and retrieve corresponding service(s) subscribed to by the particular telephone subscriber from the AIN services portion 310, here, the AIN service 1 and AIN service 2.

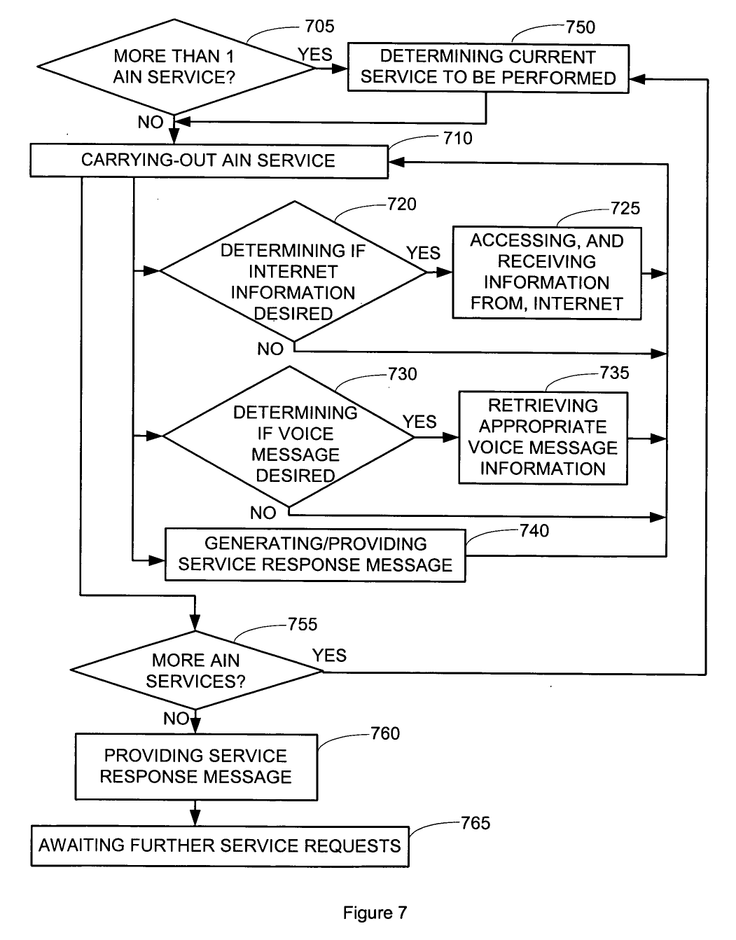

Upon determining 410 the AIN service(s) subscribed by the telephone subscriber, the AIN service(s) is performed 415 as described with respect to the flowchart of FIG. 7.

FIG. 7 is a flowchart describing performing AIN service(s) at the INN, in accordance with an embodiment of the invention. As shown in FIG. 7, the application server determines 705 whether more than one AIN service was determined forthe telephone subscriber. The determining an AIN service 410 may be utilized in the determining 705 whether the subscriber subscribes to more than one AIN service. Where it is determined 705 that the telephone subscriber subscribes to only one AIN service, the application server 110 accesses preprogrammed logic in carrying-out the AIN service, as shown at block 710. In carrying-out the AIN service, the application server 110 may determine that Internet information is desired at 720, a voice message is desired at 730, and/or a service response message is to be generated, and in some circumstances provided at 740, as discussed below.

The application server 110 may determine 720 whether information from the Internet is desired to carry-out the AIN service. Where Internet information is desired at 720, the Internet may be accessed and information retrieved, as shown at block 725. This may be accomplished, for example, by generating an Internet request message (i.e., an HTTP request message), and sending the HTTP request message from the INN 100 to the Internet, via the packet-based Network 150. The HTTP communication protocol, for example, HTTP/1.0, is well known to one skilled in the art, and defined in standard IETF RFC1945 of May, 1996, that is hereby incorporated by reference herein. Other HTTP versions may be utilized. The application server 110 may generate the HTTP request message by sending a request to the translator 120 to generate an HTTP request message to a particular Internet site to request information. The translator 120 may then return the HTTP request message to the application server 110, that forwards the HTTP request message on to the packet-based network 150. Upon receiving an Internet response message (i.e. an HTTP response message) to the HTTP request message, the application server 110 may provide the HTTP response to the translator 120 for translation, where the translator retrieves the pertinent information from the HTTP response message and provides the information to the application server 110.

In the alternative, one skilled in the art will realize that after generating the HTTP request message, the translator 120 may place the HTTP request message onto the Internet via the packet-based network 150 using a communication link between the translator 120 and packet-based network 150 (not shown). In this case, the translator awaits the HTTP response message, translates the HTTP response message, and provides the pertinent information to the application server 110.

In another alternate embodiment, the application server 110 may be sufficiently programmed for communicating in the HTTP communication protocol. In this case, the application server 110 may generate the HTTP request message, transmit the HTTP request message to the Internet via the packet-based network 150, and await the HTTP response message. As the application server 110 is capable of interpreting the HTTP response message, the application server then may parse the HTTP response message for pertinent information in providing the AIN service.

The information retrieved from the Internet by the INN 100 may be, for example, a Homeland Security Threat Advisory Level, for example, where the telephone subscriber subscribes to a Homeland Security Reroute AIN Service that routes telephone calls based on the Threat Advisory Level. In this case, call control such as call blocking, call restriction or other call control may be carried-out responsive to-the retrieved Homeland Security Threat Advisory Level.

It is determined at 730 whether a voice message is desired for providing the AIN service. Where it is determined that a voice message is desired, an appropriate voice message information may be retrieved at 735. For example, the retrieving the appropriate voice message information may be accomplished by the application server 110 sending an indication as to a particular AIN service being provided to the media server 130, where the media server uses resident logic to determine an appropriate voice message identification, and retrieve from an internal database (not shown) the appropriate digitized voice message information. In the alternative, the application server 110 may provide the media server 130 with a VM identifier, indicating the particular voice message information to be provided. The appropriate voice message may then be provided to the application server 110.

Where the media server does not maintain an internal database, the media server may determine an appropriate voice message identification, and retrieve the voice message corresponding to the voice message identification from the database 140. For example, the media server 130 may determine that the appropriate voice message is a voice message #87 (i.e. indicating that a telephone call cannot be completed), access the voice message portion 330 of the database 140, and retrieve the digitized voice message content #87 corresponding to the voice message identifier #87. The media server may then forward the voice message content #87 to the application server 110.

It may be determined at block 740 whether a service response message is to be generated, and in some circumstances described further below, provided, for use in carrying-out the AIN service. The service response message may comprise one or more information packets, sent between the INN 100 and the packet-based subscriber, that are used in carrying-out the AIN service(s). The service response message may be generated at the INN 100, and include call control information, for example, to restrict, forward, or otherwise affect a telephone call initiated by the packet-based telephone subscriber. In addition, or in the alternative, the service response message may provide a voice message to a calling or called party, indicating pertinent information regarding the attempted telephone call. Such voice information may, for example, describe a particular routing of the telephone call, or may be used to request further information from the packet-based telephone subscriber.

In some circumstances, a service response message generated at 740 may be provided to the packet-based subscriber during the performance of a particular AIN service, or before all possible AIN services have been performed for the packet-based subscriber. For example, where it is determined that additional information is desired for carrying-out the AIN service, such as a PIN number to allow the telephone call to proceed, a service response message in the form of a voice message requesting the information may be generated and provided at block 740.

In other circumstances, a service response message may be generated to carry-out a particular call routing (or blocking) at block 740. In these circumstances, the service response message may not yet be provided to the packet-based subscriber at block 740, pending the carrying-out of other possible AIN services for the packet-based subscriber, as discussed below.

Where the service response message indicates call control information, describing how a call is to be routed, the service response message may be generated 740 where the application server 110 may use preprogrammed logic to generate the service response message indicating the appropriate routing of the call. The application server 110 may provide the translator 120 the destination information and the source information for the telephone call, and the translator 120 may generate the service response message in the appropriate packet-based communication protocol. The service response message may then be provided from the translator 120 to the application server 110. The application server 110 may then temporarily hold (i.e. not provide at block 740) the service response message, pending other possible AIN services that may be performed for the packet-based telephone subscriber.

Where the service response message indicates call control information describing that a call is not to proceed (i.e. that the call is to be blocked), the service response message may be generated 740 where the application server 110 indicates, in a predetermined convention between the INN 100 and the packet-based subscriber, that the call cannot proceed. The application server 110 provides the appropriate information, including the source information for the call, to the translator 120 for translation of the service response message into the packet-based protocol. The application server 110 may then temporarily hold (i.e. not provide at block 740) the service response message, pending other possible AIN services that may be performed for the packet-based telephone subscriber.

Where the service response message is to be a voice message to the packet-based subscriber, provided during the carrying-out of an AIN service, the application server 110 may generate 740 one or more packet-based service response messages destined to the telephone subscriber to convey the voice message to the subscriber. The voice message may be used to provide pertinent call information to the packet-based subscriber. The voice information (i.e., in a digitized form) is forwarded to the translator 120 along with the source information (i.e., the packet-based telephone subscriber), where it is converted to one or more service response messages in the packet-based communication protocol. The service response message(s) may then be provided from the translator 120 to the application server 110. The application server 110 may then temporarily hold (i.e. not provide at block 740) the service response message, pending other possible AIN services that may be performed for the packet-based telephone subscriber.

Where the service response message is a voice message (i.e., announcement) requesting further information from the packet-based subscriber to carry-out an AIN service (i.e., requesting a Personal Identification Number (PIN)), the application server 110 may generate and provide the service response message at block 740. This may be accomplished by the application server 110 utilizing the translator 120 to convert the voice message to the packet-based communication protocol, for example the Real Time Protocol (RTP) Streaming communication protocol, and provide to the subscriber at block 740 the service response message with the voice message requesting further information. The application server 110 may then wait for the appropriate information to be entered by the packet-based subscriber, for example, using the packet-based telephone handset. Where the INN 100 includes an Interactive Voice Response (IVR) system (not shown), the requested information may alternatively be spoken by the packet-based subscriber, and determined using the IVR system at the INN. Any returned information from the packet-based subscriber (i.e. information or voice) may be translated from the packet-based communication protocol at the translator 120, and the information provided to the application server 110 for use in providing the AIN service.

Returning to block 705, where it is determined that there is more than one AIN service subscribed to by the packet-based telephone subscriber, a current AIN service to be performed may be determined at block 750. For example, the application server 110 may access the database 140, specifically the service order portion 320, to determine which of the AIN services subscribed to by the packet-based telephone subscriber is to be performed first. This may then be determined to be the current AIN service to be performed by the application server 110, and flow may continue to block 710 where the current service is carried-out as described above.

After carrying-out the AIN service at block 710, the application server 110 may determine at block 755 whether there are further AIN services to be performed for the telephone subscriber. As will be appreciated by one skilled in the art, in some circumstances, the performance of one AIN service may render the performance of subsequent AIN services unnecessary or otherwise inappropriate. Such a situation may occur, for example, where a disaster-routing type service is currently “active”, causing all telephone calls to the telephone subscriber to be immediately forwarded to another destination, or where a parental-control type service is “active”, causing all telephone calls received for the telephone subscriber after a particular time of the day to be blocked. In these situations, subsequent AIN services that may be subscribed to by the telephone subscriber may not be performed. Thus, the determining 755 whether there are more AIN service to be performed may account for the situation where carrying-out of one AIN service renders unnecessary or undesirable the carrying-out of additional AIN services that the telephone subscriber may subscribe to. In this case, the determining 755 may result in a “NO” determination, even where the telephone subscriber subscribes to additional AIN service not yet performed.

Where further AIN services need to be performed, flow may return to block 750 until all desired or subscribed AIN services have been performed. When carrying-out 710 the additional AIN services, the generating 740 of service response messages, for example, to provide routing information for a telephone call, may overwrite previously generated service response messages.

Where it is determined at block 755 that there are no other AIN services to be carried-out, the INN 100 may provide any previously generated service response messages that have not yet been provided to the telephone subscriber, as shown at block 760. To accomplish this, the application server 110 may determine any service response messages generated to provide call routing information and/or voice messages, that have been generated at block 740, but not yet provided. These service response messages may then be provided by the application server 110 sending them to the packet-based network 150, and thus to the packet-based subscriber.

After providing any required service response message at block 760, the INN 100 determines at 765 that it is done performing all AIN services for the particular packet-based telephone subscriber, and awaits an indication (i.e., a service request message) to perform AIN services for the same, or another, packet-based telephone subscriber.

The AIN services that may be provided by the INN 100 may include, but are not limited to, a privacy management service, a caller identification service, an outgoing call controlling service, a homeland security rerouting service, call notification, call logging, flexible call forwarding, pre-paid telephone service, or any other AIN service that may traditionally be provided by a SCP.

In accordance with another embodiment of the invention, the INN may utilize an AIN device, for example, an SCP coupled with the INN, in carrying-out an AIN service. Having an INN that may utilize a coupled AIN device in the performing one or more AIN services frees-up the finite resources of the INN, thereby allowing the INN to provide additional services to more packet-based or PSTN telephone subscribers.

FIG. 8 is a block diagram of an INN 100′ that is coupled with an Intelligent Network device that may be used in carrying-out an AIN service, in accordance with an embodiment of the invention. Elements of FIG. 8 that are identified by reference numbers previously described are the same, and will not be discussed in detail. As shown in FIG. 8, the AIN peripheral 160 may include one or more attached IN devices, for example, an SCP 805 and an SCP 810. The SCP 805 and SCP 810 may be communicatively coupled with the INN 100′ in any fashion, for example, using existing AIN infrastructure, such as SS7 signaling over SS7 links, as will be appreciated by one skilled in the art. The INN 100′ may appear to the attached SCPs 805 and 810 no different than an SSP of the PSTN. The database 140′ may be similar to the database 140 described above, where the database 140′ may further include an external AIN service portion as described with respect to FIG. 9.

FIG. 9 is a block diagram of a database that may be utilized with the INN 100′ of FIG. 8, in accordance with an embodiment of the invention. Elements of FIG. 9 that are identified by reference numerals previously described, are the same and will not be discussed in detail. As shown in FIG. 9, the database 140′ may include an external AIN service portion 905, listing various AIN services, and a corresponding AIN device that is coupled with the INN 100′ capable of performing the particular AIN service(s). For example, as shown in FIG. 9, the SCP 805 is shown to have capabilities for performing the AIN service 3, whereas the SCP 810 is shown to have capabilities for performing the AIN service 7. Both the SCPs 805 and 810 are shown to have capabilities for performing the AIN service 8. If an AIN service is not listed in the external AIN service portion 905, it may be indicated to the application server 110 that there is currently no AIN device communicatively coupled with the INN 100′ that is capable of performing that AIN service, and thus the service is to be performed at the INN 100′.

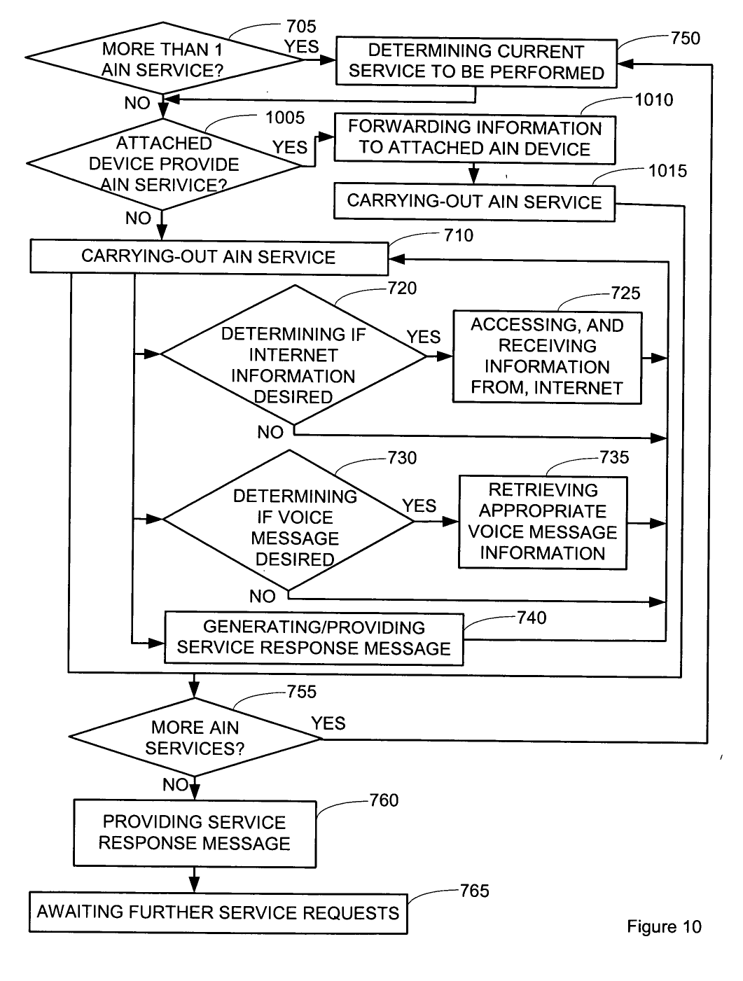

The INN 100′ of FIG. 8 may operate as described above with respect to the flowchart of FIG. 4, except that the performing the AIN service 415 may be accomplished as described with respect to FIG. 10. Thus, operation of the INN 100′ in receiving a service request message 405 and determining an AIN service 410 will not be discussed. FIG. 10 is a flowchart illustrating the INN 100′ performing 415 an AIN service using one or more Intelligent Network devices, in accordance with an embodiment of the invention. Blocks of FIG. 10 that are identified by reference numerals previously described, are the same and will not be described in detail.

As shown in FIG. 10, after it is determined 705 that there is only one AIN service to be performed, or after a current AIN service is determined 750, it is determined at block 1005 whether an AIN device (i.e. SCP 805 or SCP 810) that is communicatively coupled with the INN 100′ has capabilities for performing the AIN service to be carried-out. This may be accomplished using a database, such as the database 140′, described with respect to FIG. 9. For example, the application server 110 may access the External AIN Service Portion 905 of the database 140′ for the AIN service to be carried-out, and determine any corresponding SCP(s) having capabilities for performing the respective AIN service. Where more than one SCP coupled with the INN 100′ has capabilities for carrying-out the AIN service, the application server 110 may use some predetermined criteria for determining which SCP will be utilized in the performing of the AIN service. For example, the application server 110 may track the number of requests of the various SCPs coupled with the INN 100′ that are currently being used to perform AIN services, and select the SCP involved in the performing of the least number of AIN services.

Where there is no IN device having capabilities for carrying-out the AIN service at block 1005, flow continues to block 710 and proceeds as discussed above. However, where there is an AIN device coupled with the INN 100′ that has capabilities for carrying-out the AIN service at block 1005, the application server 110 may forward pertinent information (i.e. source information, destination information, etc. . . . ) in the form of an SS7 message such as an AIN InfoCollect Query message to the communicatively coupled AIN device, for example, the SCP 805, at block 1010. The AIN communication protocol is well known to one skilled in the art, and is defined in GR-1298-CORE, Issue 10, Nov. 2004 and GR-1299-CORE, Issue 10, Nov. 2004, as published by Telcordia Technologies, that is hereby incorporated by reference herein. Other AIN versions may be utilized.

The communications between the INN 100 and any attached AIN devices such as the SCPs 805 may occur in a similar fashion as the communication between an SSP and SCP of the PSTN. Thus, the forwarding of the pertinent information to the SCP could be conducted in much the same manner as accomplished by an SSP of the PSTN querying an SCP to providing an AIN service. In this case, the SCP includes a database (not shown) of services subscribed to by the telephone subscriber, and carries out the appropriate AIN service. The database at the SCP may also include an order to perform AIN services, where the telephone subscriber subscribes to multiple AIN services, similar to that discussed above with respect to the database 140. The SCP may then carry-out 1015 the AIN service(s) for the telephone subscriber.

After carrying out 1015 the AIN service, the SCP may respond by returning an AIN response message in the form of an AIN SendToResource message, for example, to play an announcement to the telephone subscriber. The application server 110 may then interpret the AIN SendToResource message from the SCP using the translator 120, if necessary, and generate a service response message to provide the voice message (i.e., announcement) requesting additional information from the subscriber (i.e. a telephone subscriber PIN). The application server 110 may then await the requested information, in a similar fashion as described above with respect to block 740.

The carrying-out 1015 of the AIN service may accomplished at the SCP in a fashion similar to that described above with respect to blocks 710-740. As discussed, the SCP 805 may provide an AIN response message in the form of a SendToResource message to the INN 100′ to indicate results of the performed service to the INN 100′, such as an indication to block the call, to forward the call, etc. . . . , where the application server 110 generates the service response message in a fashion as discussed above. Where carrying-out of the AIN service requires facilities of the INN 100′ that are not present within the SCP 805, the SCP 805 may access such facilities through the application server 110 in providing the AIN service. Such facilities may include accessing information from the Internet in providing the AIN service.

For example, where information from the Internet is desired in order to perform the AIN service, the SCP 805 may request such information using an AIN response message in the form of an AIN HTTP Request Get specifying the Internet site and information requested to the INN 100′. The application server 110 may then generate an Internet request message responsive to the HTTP Request Get message received from the SCP 805, in a fashion similar to that described above with respect to block 725, for example, using the translator 120 where necessary. The INN 100′ would forward the Internet information request to the Internet, for example, via the packet-based network 150, and await a response. Upon receiving the response with the requested information, the application server 110 may determine the Internet information requested, in a similar fashion as discussed above with respect to block 725, and for example, using the translator 120 where necessary. The application server 110 may then generate an AIN HTTP Response message indicating the particular information requested, and send the AIN HTTP Response message to the SCP.

In addition, where carrying-out an AIN service that requires a voice message to be provided to the packet-based telephone subscriber, the SCP 805 may generate an AIN response message in the form of a SendToResource message to the application server 110. The application server 110 may access the media server 130 to provide the appropriate voice message to the telephone subscriber, for example, as described above with respect to block 735 and 740.

Where the SCP 805 needs further information for performing an AIN service, such as to collect a PIN number from the telephone subscriber to determine whether to allow a telephone call to proceed, the SCP may send an AIN SendToResource message to the INN 100′, indicating that a particular voice message is to be provided, and a PIN number collected from the telephone subscriber. Such a message may take the form of, for example, SendToResource (conversation), PlayAnnouncement ID=xx, Number of Digits=4, where the xx corresponds to the VM identification number, describing to the media server which voice message to provide to the telephone subscriber. The INN 100′ may then provide the voice message, and collect the PIN number, in a fashion similar to that discussed above with respect to block 740 of FIG. 7.

After receiving the PIN number, the INN 100′ may return an AIN ResourceClear message back to the SCP 805, to provide the information (i.e., PIN number) back to the SCP. The AIN ResourceClear message may take the form ResourceClear (Response), Number of Digits=4 Digits=wxyz, where the wxyz represent the PIN number entered by the telephone subscriber. The SCP 805 may then validate the PIN number, and allow the telephone call to proceed. For example, the SCP 805 provides an AIN response message in the form of an AIN AnalyzeRoute Response message, specifying the calling party (i.e. the packet-based telephone subscriber) and the called party. The application server 110 may then receive this AnalyzeRoute Response message, and if necessary, utilize the translator 120 to translate it into a service response message in the packet-based protocol, in a fashion as discussed above. The application server 110 may determine whether there are further AIN services to be carried-out at block 755. Where there are no further AIN services at block 755, any unprovided (i.e., held by the application server 110) service response messages, for example, to provide routing instructions and/or a voice message for the call, may be provided at block 760, in a fashion as discussed above. The service response message may then be provided to the packet-based network/device 150, and the call processed accordingly (i.e. allowed to proceed, blocked, etc. . . . ).

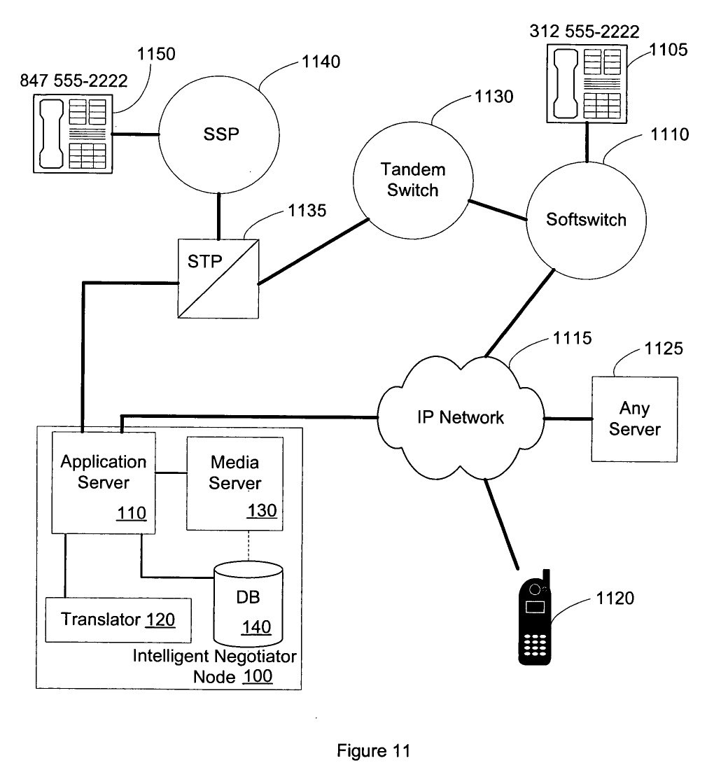

In accordance with another embodiment of the invention, a telecommunications network may include an INN that may be used to provide AIN services to packet-based telephone subscribers. The INN may further be used to provide AIN services, including AIN services requiring Internet information, to PSTN telephone subscribers. FIG. 11 is a block diagram of a telecommunications network that may utilize the INN in providing an AIN service to a telephone subscriber, in accordance with an embodiment of the invention. Elements of FIG. 11 having references numbers that have been previously described are the same, and will not be discussed in detail.

As shown in FIG. 11, a packet-based telephone subscriber 1105 having a telephone number 312 555-2222 is provided telephone service via a softswitch 1110. The softswitch 1110 may be, for example, a Cisco BTS or a Lucent Softswitch (LSS). The softswitch may include a database (not shown) linking packet-based subscribers with services that are provided by the INN 100. The softswitch 1110 may be communicatively coupled with a packet-based network such as the IP Network 1115, where the IP Network is further coupled with a mobile telephone 1120, the INN 100, or any server 1125 that may be coupled with the IP Network and utilized in providing services to a packet-based telephone subscriber. The server 1125 may include, but is not limited to, any of a unified messaging server allowing a telephone subscriber's e-mail messages to be converted to audio and read to the subscriber, and a packet-based service node/intelligent peripheral that may be used for creating packet-based telephone calls, playing announcements, performing text-to-speech performing voice recognition, collecting voice or digits, etc. . . . The INN, having capabilities for communicating in a packet-based communication protocol, has capabilities for interfacing with any server present on the packet-based network, for example, a unified messaging server, a packet-based service node/intelligent peripheral, or any other server that may be present in communication with the Internet, for example, a Sun Server running Apache Web Server. Further, the INN may provide an interface between mobile terminals (i.e., cellular telephones) and the PSTN, for example, by providing an alternate interface between a Mobile Switching Center and the PSTN. This may be possible, as the INN has capabilities for communicating using both packet-based communication protocols and the AIN communication protocol.

The softswitch 1110 is further coupled with a Tandem Switch 1130, that is coupled with a Service Switching Point (SSP) 1140 through one or more Signal Transfer Points (SSPs) 1135. The SSP 1140 is shown to provide telephone service to a PSTN subscriber, here the PSTN subscriber 1150 having a telephone number 847 555-2222. The INN 100 is further shown to be coupled with the SSP 1140 via the one or more STPs 1135.

The packet-based telephone subscriber 1105, softswitch 1110, IP Network 1115, mobile telephone 1120, the server 1125, Tandem switch 1130 and INN 100 may be coupled through any medium capable of transmitting packet-based information, for example, the Internet, where each has a corresponding address on the packet-based network. The packet-based communication protocol may include, but are not limited to, those discussed above with respect to FIG. 2. The tandem switch 1130, the STP(s) 1135, the SSP 1140 and the INN 100 may be coupled through existing SS7 infrastructure, for example through SS7 links communicating using the SS7 communication protocol. For example, as will be appreciated by those skilled in the art, common channel signaling (i.e. using signaling system seven (SS7) communication messages) may be employed between various STPs and tandem switches. Further, the SSP 1140 and the PSTN telephone subscriber 1150 may be coupled via a typical twisted-pair telephone line, and the SSP 1140 may be coupled with additional SSPs (not shown) via trunked communication lines, all operating using, for example, the SS7 communication protocol. The trunked communication lines are used to connect and carry communications signals, for example, voice and/or data, between two or more telephone network locations.

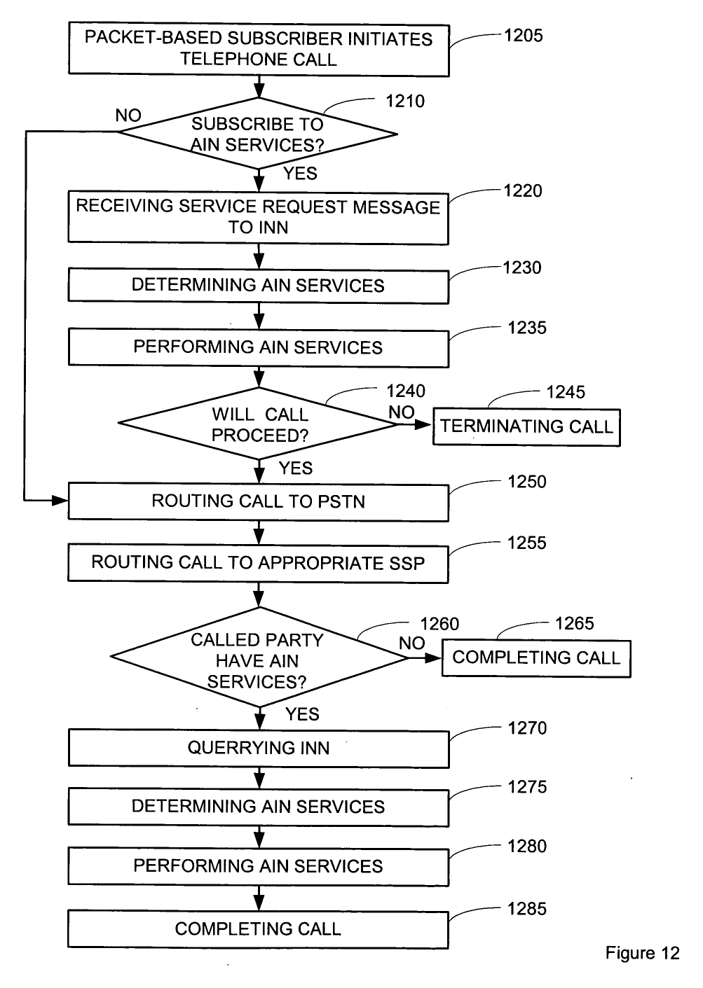

Operation of the telecommunications network shown in FIG. 11 is discussed with respect to FIG. 12. FIG. 12 is a flowchart describing operation of the telecommunications network of FIG. 11, in accordance with an embodiment of the invention. The operation of the telecommunications network of FIG. 11 will be described in the context of the SIP Version 2.0 communication protocol being used for communications between the packet-based subscriber 1105 and the softswitch 1110, and between the softswitch 1110 and the INN 100. The SIP Version 2.0 protocol is well known to one skilled in the art, and is defined in standard RFC 3261, dated June 2002, that is hereby incorporated by reference herein. Other versions of the SIP protocol may be utilized. As is known by one skilled in the art, the SIP communication protocol includes various fields describing source, destination, packet size, call-id (i.e., identification a particular call being handled), content-type (i.e., describing the content of the particular information packet), as well as predefined message types (i.e., INVITE, ACK, BYE, REGISTER, CANCEL, OPTIONS, etc. . . . ). Although particular messages are described in performing particular functions in the performing the AIN services, one skilled will appreciate that other messages may instead be employed, as well as other communication protocols, to carry-out the functionality described herein, while still achieving the advantages discussed herein. In addition, although the communication links for providing packet-based information between the packet-based subscriber 1105, the softswitch 1110, the INN 100, the tandem switch 1130, and the server 1125 are described as IP communication links, other packet-based links may be utilized in carrying-out the functionality described herein.

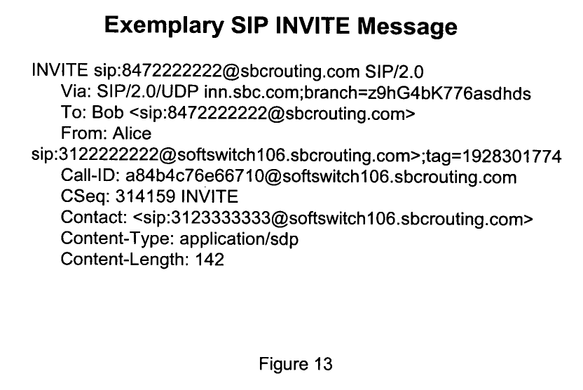

As shown at block 1205, a packet-based subscriber initiates a telephone call. This may be accomplished where the packet-based subscriber 1105 picks up his telephone handset, and dials a called party, for example, at the PSTN telephone subscriber 1150. The softswitch 1110 detects the packet-based subscriber's desire to initiate a telephone call, and determines 1210 if the packet-based subscriber subscribes to any services (i.e. AIN services) that require intervention of the INN 100. Where the softswitch 1110 determines at 1210 that the packet-based subscriber subscribes to services that require intervention of the INN 100, the softswitch generates a SIP INVITE Message, for example, having the exemplary form shown in FIG. 13. As shown in FIG. 13, the SIP Invite message may, for example, specify a destination for the call, here, 8475552222@sbcrouting.com where the sbcrouting.com is the IP address of the INN 100. As shown in FIG. 13, the SIP INVITE may also include the source information, here the IP address of the packet-based telephone, 3125552222@softswitch 106.sbcrouting.com, the softswitch 106.sbcrouting.com identifies the particular softswitch serving the packet-based telephone subscriber. Further, the SIP message may include a Call-ID field identifying the particular telephone call associated with the SIP message, that may be utilized in later generated SIP messages for the telephone call to link the later messages with the telephone call. The softswitch 1110 may then send the SIP Invite message, that is received 1220 at the INN 100 as a service request message. Where it is determined that the packet-based subscriber does not subscribe to any AIN services at block 1210, the call will be routed in a conventional manner from the packet-network to the PSTN, as shown at block 1250, described below.

The receiving 1220 the service request message (i.e., SIP Invite message) may be accomplished in a similar fashion as discussed above with respect to FIG. 5, where the SIP Invite message is received 505 at the application server 110, and forwarded 510 to the translator 120. The translator identifies 515 the communication protocol of the service request message as the SIP communication protocol. The translator then retrieves 520 information from the service request message, such as a source of the service request message, here 3125552222@softswitch 106.sbcrouting.com of the packet-based telephone subscriber, and a destination of the telephone call, here the PSTN telephone subscriber 1150 with a destination address of 8475552222@sbcrouting.com. The information (i.e., calling party 3125552222, and destination 8475552222) may then be forwarded 525 to the application server 110, as discussed above.

After the service request message is received 1220, the AIN service(s) to which the packet-based telephone subscriber 1150 subscribes is determined at block 1230. This may be determined, for example, as discussed above with respect to FIG. 6. Thus, the INN may access 605 the AIN service portion 310, locate 610 the packet-based telephone subscriber 3125552222 in the database 140, and retrieve 615 any corresponding AIN services subscriber to by the telephone subscriber, in the fashion discussed above. For example, it may be determined at block 1230 that the packet-based subscriber may subscribe to an outgoing call control (OCC) AIN service, restricting destinations to which the packet-based telephone subscriber 1105 may call.

After determining 1230 the AIN service(s) (i.e., here OCC), the AIN service(s) is performed as shown at block 1235. The performing 1235 may be accomplished in a similar fashion as discussed above with respect to FIG. 7. For example, and referring to FIG. 7, application logic present within the application server 110 may determine 705 whether multiple AIN services are subscribed to by the packet-based subscriber 1105. Information from the block 1230 determination may be used to determine whether the packet-based subscriber 1105 subscribes to multiple AIN service.

Where the packet-based subscriber 11 05 subscribes to only one service, the application server 110 carries-out 710 the AIN service in a fashion discussed above. For example, in this case, the application server 110 applies preprogrammed logic for carrying-out the OCC service. This may include determining whether Internet information is desired at 720. It is determined that Internet information is not desired for the OCC service at 720. The application server 110 may be determined whether a voice message (i.e., announcement) is desired at 730.

In determining whether a voice message is desired at 730, the application server 110 may determine whether the destination of the telephone call (i.e. the PSTN telephone subscriber 1150 with telephone number 8475552222) is a restricted destination for the packet-based telephone subscriber 1105. Where the destination is not restricted, then it may be determined that no voice message is required. However, where it is determined that the destination is a restricted destination, then it may be determined that a voice message is desired, for example, providing the packet-based subscriber 1105 with information indicating that “I'm sorry, your call is not authorized.” The appropriate voice message information may be retrieved as described with respect to block 735.

Where the destination is not a restricted destination, a service response message may be generated at block 740 in a fashion described above, to provide routing information for the call. For example, the service response message may be generated as a SIP 301 MOVED TEMPORARILY message, setting the source as the packet-based subscriber 1105 and the destination as the PSTN telephone subscriber 1150.

In the case where the destination is a restricted destination for the packet-based subscriber 1105, a service response message may be generated 740 indicating a voice message “I'm sorry, your call is not authorized” for the packet-based subscriber. The service response message may be generated as a SIP 200 OK message, that may connect the INN 100 with the packet-based subscriber 1105 via a voice path. Since the OCC may allow for a PIN number to be entered by the packet-based subscriber to override a restricted call destination, the service response message may additionally be provided at block 740 to request a PIN from the packet-based subscriber where the application server 110 awaits entry of the PIN from the packet-based subscriber 1105.

To provide the voice message, a constant flow of voice packets, for example, transmitted within the RTP Streaming communication protocol, or another protocol depending on vendor and implementation, is communicated between the INN 100 and the softswitch 1110, and between the softswitch 1110 and the packet-based subscriber 1105. For example, the application server 110 may generate the SIP packet-based messages by sending appropriate information to the translator 120 (i.e. the destination of the message and the information to be transmitted, here voice message information), where the translator converts the information to the appropriate SIP message. The SIP 200 OK message is provided to the application server 110 and sent to the packet-based telephone subscriber 1105 through the softswitch 1110.

The softswitch 1110 receives the SIP message, and provides the voice packets to the packet-based subscriber 1105 via the SIP communication protocol. Messages may be sent from the packet-based telephone subscriber 1105 to the INN 100 indicating receipt of the SIP messages, where the softswitch 1110 generates SIP messages to be sent to the INN 100 indicating receipt of the SIP message(s). The application server 110 of the INN 100 then forwards the received SIP messages to the translator 120 for translation.

Where the OCC service allows for a PIN number to override the OCC service, the packet-based subscriber 1105 may enter the PIN at his telephone handset. The packet-based subscriber's 1105 telephone may then generate a packet-based message to the softswitch 1110, that converts the message to a SIP message such as a SIP INVITE message that is forwarded to the INN 100. The PIN number may be provided within the SIP message by whatever predetermined convention sufficient for transmitting such information. For example, the PIN number may be provided as a series of SIP messages representing audible DTMF tones to transmit the entered PIN number, in the same way as voice is transmitted via the SIP messages. The INN 100 may include a DTMF decoder (not shown) for decoding the received DTMF tones provided by the packet-based subscriber. In the alternative, the PIN number may be converted to binary symbols, such as ASCII codes, where each binary symbol represents a digit of the PIN. These symbols may then be sent to the INN as information, via one or more suitable SIP messages. The application server 110 may then utilize the translator 120 in determining the PIN number entered by the packet-based subscriber 1105.

Where the PIN number has been validated, the application server 110 generates at block 740 a service response message indicating that the telephone call is allowed to proceed. For example, the application server 110, through the assistance of the translator 120, may generate a SIP 301 MOVED TEMPORARILY message, setting the source as the packet-based subscriber 1105 and the destination as the PSTN telephone subscriber 1150. As described above, the service response message may be temporarily held at the application server 110 pending additional AN services that may be carried out for the telephone subscriber.

Where the PIN is incorrect, the application server 110 generates at block 740 a service response message indicating that the telephone call is to be blocked. For example, the application server 110, through the assistance of the translator 120, may generate an appropriate SIP message to the softswitch 1110 indicating that the call is to be blocked. For example, the application server, with the assistance of the translator 120, may use some predetermined convention between the INN and the softswitch to generate a SIP message indicating that a call is to be blocked. The predetermined convention may be, for example, some predetermined bit pattern present within one of the fields of the SIP message, and/or the particular SIP message-type generated as the service response message. The SIP message may indicate the destination of the message as the packet-based subscriber 1105, may be used to provide a voice message to the telephone subscriber indicating that the telephone call is blocked, and may indicate to the softswitch 1110 (i.e. through the predetermined convention) that the telephone call is to be blocked/terminated. As described above, the service response message may be temporarily held at the application server 110 pending additional AIN services that may be carried-out for the telephone subscriber.

After generating (and providing where necessary) any service response messages at block 740, and once the AIN service is carried out at block 710, it is then determined at block 755 whether there are additional AIN services to be carried out for the packet-based telephone subscriber, as described above. In this case, there are no more AIN services to be carried-out for the packet-based telephone subscriber 1105.

Any generated service response messages are then provided as shown at block 760, here a service response message comprising a SIP 301 MOVED TEMPORARILY message, setting the source as the packet-based subscriber 1105 and the destination as the PSTN telephone subscriber 1150, as the destination is not a restricted destination for the packet-based subscriber.

Returning to FIG. 12, it is determined at the softswitch 1110 whether the call will proceed at block 1240. This may be determined by examining the service response message returned by the INN 100. For example, where the service response message indicates that the call is to be blocked, it is determined that the call will not proceed at block 1240, and the call is terminated as shown at block 1245. However, where the service response message indicates that the call will proceed, for example, by providing routing information for the telephone call, or where it is determined that the packet-based subscriber 1105 does not subscribe to any AIN services at block 1210, the call is routed to the PSTN as shown at block 1250. This is accomplished by the softswitch 1110 receiving the SIP 301 MOVED TEMPORARILY message from the INN 100 in the case of the performing 1235 AIN services, or utilizing the SIP INVITE message generated at the softswitch 1110 where the packet-based subscriber 11 05 was determined not to subscribe to any AIN services at block 1210. The respective SIP message is then used to forward the call to the PSTN via the tandem switch 1130, and specifically, to an IP translator (not shown) associated with the tandem switch 1130.

At block 1255, the telephone call is routed from the tandem switch to an appropriate SSP serving the PSTN telephone subscriber 1150. This may be accomplished by the tandem switch generating a Call Setup message in the SS7 communication protocol, setting a calling party as 3125552222 (the packet-based telephone subscriber 1105) and the called party as 8475552222 (the PSTN telephone subscriber 1150). It is then determined whether the called party, here the PSTN telephone subscriber 1150, subscribes to any AIN services at block 1260. This may be accomplished, for example, at the SSP 1140 by determining whether there is a Termination Attempt Trigger (TAT) associated with the PSTN telephone subscriber 1150, where the existence of a TAT indicates that the PSTN telephone subscriber 1150 subscribes to one or more AIN services.

Where it is determined 1260 that the PSTN telephone subscriber 1150 does not subscribe to any AIN services, the call may be completed, as shown at block 1265, where the PSTN telephone subscriber 1150 telephone rings. However, where it is determined that the PSTN telephone subscriber 1150 does subscribe to one or more AIN services at 1260, the INN 100 may be queried as shown at block 1270. This INN querying may be accomplished, for example, by the SSP 1140 launching an AIN Termination Attempt Query, Calling=3125552222 (Presentation=Allowed), Called=8475552222. The INN 100 may then act in a manner similar to that of a conventional SCP, and provide AIN services subscribed to by the PSTN telephone 1105. However, unlike conventional SCPs, the INN 100 has capabilities for accessing the Internet for information used in providing an AIN service.

The INN 100 may then determine AIN services for the PSTN telephone subscriber 1150 as shown at block 1275. This may be accomplished in a similar fashion as discussed above with respect to FIG. 6. The INN 100 may, for example, determine at block 1275 that the PSTN telephone subscriber 1150 subscribes to a homeland security reroute service, a caller identification service, and a privacy management service.

After determining the AIN services at 1275, the INN 100 may then perform the services as shown at block 1280. The performing 1280 may be accomplished in a similar fashion as discussed above with respect to FIG. 7. Referring to FIG. 7, the INN may determine 705 that there is more than one AIN service to be performed. It may then be determined that the current service to be performed at 750 is Homeland Security Reroute (i.e. after accessing the Service Order Portion 320 of the database 140). The homeland security reroute service may be carried-out at block 710. It may be determined at block 720 that Internet information is desired for the Homeland Security Reroute AIN service, as the application logic corresponding to the homeland security reroute service indicates that Internet information is desired. The internet is accessed by the INN 100, and information is retrieved from the Internet, as shown at block 725. This may be accomplished, for example, by the application server 110, alone or through use if the translator 120, generates an Internet request message in the for of an HTTP REQUEST GET www.dhs.gov.dhspublic.getAdvisoryCondition message that is transmitted to the Internet, for example via the IP network 1115. The HTTP RESPONSE Threat_Advisory Condition=“ELEVATED” may be an XML message received at the application server 110 as an Internet response message. The information may be extracted from the HTTP Response Message, by the application server 110 or with the assistance of the translator 120 as described above, and utilized in providing the homeland security reroute service. Where the threat advisory condition exceeds some predetermined threshold, the AIN service may indicate to route a telephone call to a different telephone number. However, where the threat advisory condition does not exceed the threshold, the telephone call may be allowed to proceed. In this case, the advisory condition “elevated” does not exceed the threshold for rerouting the telephone call.

The application server 110 determines whether any voice message is desired at 730. Here, as the telephone call does not need to be rerouted, no voice message is desired. However, where the call is to be rerouted in response to the Homeland Security Reroute service, it may be determined that a voice message is desirable to explain to the calling party that the call is being rerouted, and the voice message may be determined at block 735, and a service response message generated at block 740. The generation of the service response message occurs in a different fashion than described above, as the INN 100 is interfacing with an SSP of the PSTN.

For example, the service response message may be generated to provide a voice message to the packet-based subscriber 1105, or to provide routing instructions for the call to the SSP 1140. Unlike discussed above with respect to block 740, a service response message to provide a voice message may be in the form of an AIN SS7 message, for example, a SendToResources message, indicating an identification (i.e., via a PlayAnnouncement ID=xx) of the particular message to the SSP, in a fashion as would be provided by a typical SCP to an SSP of the PSTN. As discussed above, the service response message may be temporarily held by the INN 100 until other possible AIN services are performed. Since the Terror Alert Level is not sufficient to require rerouting of the telephone call, no service response message is generated at block 740.

It is then determined whether there are more AIN services to be performed at block 755. As the PSTN telephone 1250 subscribes to more than one AIN service, flow returns to block 750, where the Privacy Manager AIN service is determined to be the current service.

The privacy management service, allowing the subscriber to restrict incoming calls to his telephone, is then carried out at the INN 100 at block 710, and it is determined that Internet information is not required at 720. It is then determined whether a voice message (i.e., announcement) is desired at block 730. Here, the packet-based telephone subscriber 1105 is recognized as a calling party that does not require screening. For example, and as will be appreciated by one skilled in the art, this may be determined using service characteristics of the telephone call, and/or may be determined using a list of telephone numbers, provided at the INN (i.e., at the database 140), that are authorized to call the privacy manager subscriber. In this case, as the telephone subscriber 1105 is recognized as a calling party that does not require screening, no voice message is required. Further, since the packet-based telephone subscriber is recognized as a calling party that does not require screening, no service request message is generated at block 740.

It is then determined at block 755 that there are more AIN services to be performed, and flow returns again to block 750, where the current service is determined to be caller identification. The INN 100 then performs the Calling Name service, determining that no Internet information or voice message is desired at blocks 720 and 730, and generating a service response message at 740. As the INN 100 recognizes that the service response message is to go to a PSTN network element (here, the SSP 1140), the service response message is generated as an AIN SS7 message, here, an AIN SS7 Authorize Termination (Response) Name=“Doe, Jane”, Number 3125552222, Date=“121720041630”, where the “Name” field includes the name of the calling party, here the packet-based subscriber 1105, and the Date includes the date and time of the telephone call, here Dec. 17, 2004 at 4:30 PM. In this case, the application server 110 does not yet send the service response message, pending other possible AIN services that the PSTN telephone subscriber 1150 may subscribe to.

It is then determined that no more services are to be provided at block 755. It is then determined that there is a service response message to be provided at block 760. The application server 110 then provides the service response message, here the generated AIN SS7 Authorize Termination (Response) message to the SSP 1140. Returning to FIG. 12, the SSP 1140 then completes the telephone call as shown at block 1285, where the PSTN telephone subscriber 1150 telephone rings, and caller identification information is provided to the PSTN telephone subscriber 1150.

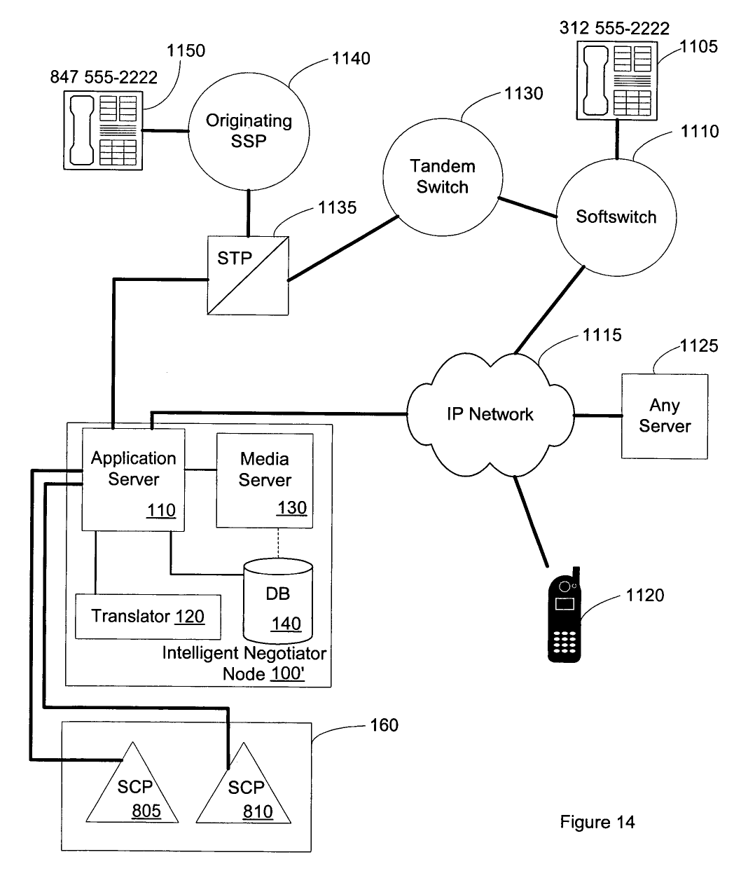

FIG. 14 illustrates a block diagram of a telecommunications network that includes an INN coupled with additional AIN devices in providing AIN services, in accordance with an embodiment of the invention. Elements of FIG. 14 that have been previously described are the same, and will not be discussed in detail. As shown in FIG. 14, the INN 100′ is further coupled with AIN devices, here SCPs 805 and 810, that may be utilized by the INN 100′ in the carrying-out of AIN services for a packet-based and/or PSTN telephone subscriber. The providing of the AIN services by the INN 100′ to the packet-based telephone subscriber 1105 and/or the PSTN telephone subscriber 1150 may be accomplished in a similar fashion as discussed with respect to the flowchart of FIG. 12, and will not be further discussed. The utilization of the SCPs 805 and/or 810 by the INN 100′ in the performance of AIN services may be accomplished in a fashion similar to that described above with respect to FIGS. 8-10, and will not be further discussed.

Although the INN 100 and INN 100′ have been discussed as providing AIN services to the packet-based telephone subscriber when the packet-based subscriber initiates the telephone call, it will be apparent to one skilled in the art that the INN 100 and INN 100′ may be utilized to provide AIN services to a calling party where the packet-based subscriber is the called party. For example, and referring to FIG. 11, where the PSTN telephone subscriber 1150 initiates a telephone call to the packet-based telephone subscriber 1105, the call may proceed through the PSTN network, through the Tandem switch 1130, and to the softswitch 1110. At this point, the softswitch 1110 may determine that a telephone call to the packet-based subscriber 1105 requires intervention of the INN (i.e., the packet-based telephone subscriber 1105 subscribes to one or more AIN services). At this point, in a fashion similar to as described above, the softswitch may send a service request message to the INN 100, for example, in the form of a SIP INVITE Message, and the INN may provide any AIN services for the packet-based telephone subscriber. The incoming call to the packet-based subscriber 1105 may then be handled according to any AIN services (i.e. rerouted, blocked as in the case of a privacy management service, routed to voice mail, etc. . . . ) provided to the packet-based subscriber 1105 by the INN 100, in a similar fashion as described above.

In addition, although the packet-based protocol described above with respect to FIGS. 11-13 is the SIP protocol, one skilled will realize that other packet-based communication protocols may be appropriate in addition to, or in the alternative of, the SIP protocol, at the INN 100, or for communication between the INN and other elements of the packet-based environment.

Further, one skilled in the art will realize that when implementing the INN 100, it may be desirable that the received packet-based messages be translated to a higher-level communication protocol, for use at the INN 100. For example, one skilled will realize that SIP messages received at the INN may be converted at the INN 100 (i.e., using the translator 120) to the higher-level Parlay communication protocol, where the various components of the INN 100 interact through the use of the Parlay application programming interfaces (API's) Version 4.1. The Parlay API's are well known to one skilled in the art, and are defined in standard ETSI ES 202 915-[1-12], dated August, 2003, that is hereby incorporated by reference herein. Other versions of the Parlay API may be utilized.

As the Parlay API resides at a higher level than the SIP protocol, use of the Parlay API may render development and improvements to the INN 100 by software developers less complicated than where the SIP protocol is utilized within the INN 100. Thus, SIP messages such as SIP INVITE, REROUTE TEMPORARILY, etc. . . . messages may be received at the INN 100, and converted at the translator 120 to the Parlay API messages (i.e., routeRes( ), routeReq( ), getCallInfoReq( ), getCallInfoRes( ), etc. . . . ). In this way, the INN 100 may be continually developed, for example, in a Java-implemented Parlay message format, thereby easing access to and use of the SIP messages received at the INN 100. One skilled will realize that implementation of the INN 100 using Parlay for interaction between the various elements of the INN is merely exemplary, and any implementation scheme of the INN 100 may be utilized using any communication protocol, while still achieving the functionality and advantages discussed herein.

Although the various databases discussed above each show a specific number of database entries, such database file representations are merely exemplary, and one skilled in the art will realize that any number of database entries may be provided for each of the respective database files. Further, although multiple exemplary database files are described, one skilled will appreciate that the information stored in the various databases may be maintained in a single database file, or any other number of database files, so long as the application engine 110 is programmed with information regarding from which database(s) to retrieve the various information stored. Further, although the information is described as being stored in the form of one or more database files at the database 140, one skilled will realize that the information may be stored in other formats, so long as the application engine 110 is sufficiently programmed for retrieving the data.

The packet-based subscriber may be a subscriber that receives telephone service via the Internet, for example, in a Voice over IP environment, or may be a telephone subscriber that receives telephone service via a private IP-based network, or any other packet-based network via any packet-based communication protocol. Although the embodiments discussed with respect to the flowchart of FIG. 12 disclose various SIP message types used in carrying-out the functionality disclosed herein, it will be appreciated by one skilled in the art that other SIP message types, or information packets utilizing other packet-based communication protocols, may be employed to perform the disclosed functionality, while achieving the advantages discussed herein. In addition, although the operation discussed with respect to the flowcharts of FIGS. 7 and 10 disclose a particular order of steps for operation of the INN, for example, in carrying-out an AIN service, it will be appreciated by one skilled in the art that the order of the steps performed may be altered, and in some circumstances that alternative steps or less steps than described may be utilized, during the performing of the functionality disclosed for the INN, while still achieving at least some of the advantages discussed herein.

Thus, an INN is provided that is capable of providing AIN services to a packet-based telephone subscriber. As the INN has capabilities for communicating in a packet-based communication protocol, it may communicate with both packet-based subscribers, as well as PSTN devices using SS7 protocol, thereby allowing existing AIN services of the PSTN to be provided to packet-based telephone customers. Further, the INN has capabilities for providing voice messages to a packet-based telephone subscriber while providing the AIN service, thereby allowing important or otherwise pertinent audible information to be provided to the packet-based telephone subscriber while performing the AIN service. In addition, as the INN has capabilities for communicating using a packet-based communication protocol, such as HTTP protocol, it has capabilities for retrieving information from the Internet that may be utilized in providing an AIN service to both packet-based and PSTN telephone subscribers.

Further, having the INN with capabilities of using AIN devices such as SCPs that are coupled with the INN in providing AIN services allows the INN to free-up resources, thereby allowing the INN to provide additional, and/or, existing AIN services to a greater number of packet-based telephone subscribers.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method of providing an Advanced Intelligent Network (AIN) service for a packet-based telephone subscriber using an Intelligent Negotiator Node (INN), the INN capable of communicating using a packet-based communication protocol, comprising:
receiving a service request message at the INN including information in a packet-based protocol, the information including an identification of a packet-based telephone subscriber;
determining at the INN the AIN service subscribed to by the packet-based telephone subscriber; and
performing at the INN the AIN service subscribed to by the packet-based telephone subscriber.

2. The method of claim 1, further comprising determining whether a packet-based telephone subscriber subscribes to an AIN service.

3. The method of claim 2, where
the packet-based telephone subscriber is coupled with the INN via a softswitch, and
the determining whether the packet-based telephone subscriber subscribes to an AIN service includes determining at the softswitch whether the packet-based telephone subscriber subscribes to an AIN service.

4. The method of claim 3, further comprising:
generating the service request message at the softswitch responsive to determining whether the packet-based telephone subscriber subscribes to an AIN service; and
sending the service request message from the softswitch to the INN.

5. The method of claim 4, where the performing the AIN service includes:
providing a service response message from the INN to the softswitch, describing how the call is to be routed responsive to the AIN service being performed for the packet-based telephone subscriber; and
routing the call from the softswitch through an interface point of the public switched telephone network, responsive to the routing message from the Intelligent Negotiator Node.

6. The method of claim 5, where the interface point is one of a service switching point and a tandem switching point.

7. The method of claim 6, where the interface point includes translation capabilities for converting a packet-based protocol to an Advanced Intelligent Network protocol.

8. The method of claim 4, where the performing the AIN service includes:
determining through performance of an AIN service that the telephone call is unauthorized at the INN; and
providing a service response message from the INN to the softswitch indicating that the telephone call is to be blocked.

9. The method of claim 4, where the performing the AIN service includes providing a service response message comprising a voice message from the INN for the packet-based telephone subscriber indicating a status of the packet-based telephone call.

10. The method of claim 4, where the performing the AIN service includes providing a service response message to the softswitch requesting information from the packet-based telephone subscriber for use in providing the AIN service.

11. The method of claim 4, where the performing the AIN service includes:
determining that the telephone call is unauthorized at the INN;
providing a service response message comprising a voice message from the INN to the packet-based telephone subscriber indicating that the telephone call will be blocked unless a predetermined sequence of keypad digits are entered at the packet-based telephone;
accepting a sequence of packet-based telephone keypad digits;
determining at the INN whether the entered sequence of keypad digits is equal to the predetermined sequence of keypad digits; where
if the entered sequence of keypad digits equals the predetermined sequence of keypad digits, providing a service response message to the softswitch allowing the packet-based telephone call to proceed, and
if the entered sequence of keypad digits does not equal the predetermined sequence of keypad digits, providing a service response message to the softswitch indicating that the packet-based telephone call is to be blocked.

12. The method of claim 4, where the INN is communicatively coupled with a service control point (SCP), and the performing the AIN service includes:
determining whether the SCP has capabilities for providing the AIN service; and
utilizing the SCP in the performance of the AIN service for the packet-based telephone subscriber where the SCP has capabilities for performing the AIN service.

13. The method of claim 12, where the directing the SCP to perform the AIN service includes:
generating an AIN query message from the INN to the SCP including information to provide the AIN service;
performing the AIN service at the SCP;
generating an AIN response message from the SCP to the INN responsive to the performing the AIN service; and
generating a service response message at the INN responsive to the AIN response message, for performing the AIN service.

14. The method of claim 1, where the performing the AIN service includes
initiating an Internet request message to the Internet, and
utilizing information received in the Internet response message received from the Internet in reply to the Internet request message in performing the AIN service.

15. The method of claim 1, where the packet-based communication protocol includes at least one of a Session Initiation Protocol, a Parlay message, an Internet Protocol, a Hypertext Transfer Protocol, a File Transfer Protocol, and an Extensible Markup Language protocol.

16. The method of claim 1, further comprising:
receiving at the softswitch an incoming telephone call for a packet-based telephone subscriber; and
generating a service request message to the INN to determine what AIN services are subscribed to be the packet-based telephone subscriber.

17. A method of providing an Advanced Intelligent Network (AIN) service for a telephone subscriber at an Intelligent Negotiator Node (INN) using information from the Internet, comprising:
determining that Internet information is desired at the INN;
translating a request for desired information into an Internet request message at the INN; and
performing the AIN service at the INN using information retrieved from an Internet response message received from the Internet responsive to the Internet request message.

18. The method of claim 17, where the telephone subscriber is a packet-based telephone subscriber.

19. The method of claim 17, where the telephone subscriber is a Public Switched Telephone Network telephone subscriber.

20. An Intelligent Negotiator Node (INN) for use in a telecommunications network that is capable of providing at least one Advanced Intelligent Network (AIN) service to a packet-based telephone subscriber, comprising:
an application server capable of receiving a service request message in a packet-based communication protocol, and of providing an AIN service responsive to the service request message, the providing including generating at least one service response message in response to the AIN service being performed;
a translator, coupled with the application server, for extracting information from the service request message for use by the application server in providing the AIN service, and for operating with the application server in generating the service response message by converting resultant information from the performing of the AIN service to a packet-based communication protocol; and
a memory coupled with the application server for storing information regarding AIN services subscribed to by a plurality of packet-based telephone customers.

21. The Intelligent Negotiator Node of claim 20, further comprising a media server coupled with the application server, for providing voice message information for use in providing the AIN service.

22. The Intelligent Negotiator Node of claim 21, where the service response message comprises a voice message for the packet-based telephone subscriber indicating a status of the packet-based telephone call.

23. The Intelligent Negotiator Node of claim 20, where the telecommunications network includes a softswitch used in providing telephone services to the packet-based telephone subscriber, and the service response message indicates routing information to the softswitch for a telephone call of the packet-based telephone subscriber.

24. The Intelligent Negotiator Node of claim 23, where the telephone call is an incoming telephone call for the packet-based telephone subscriber.

25. The Intelligent Negotiator Node of claim 23, where the telephone call is an outgoing telephone call from the packet-based telephone subscriber.

26. The Intelligent Negotiator Node of claim 20, where the telecommunications network includes a softswitch used in providing telephone services to the packet-based telephone subscriber, and the service response message indicates to the softswitch to block the telephone call of the packet-based telephone subscriber.

27. The Intelligent Negotiator Node of claim 20, where the application server providing an AIN service includes the application server generating an Internet request message to retrieve information from the Internet for use in providing an AIN service.

28. The Intelligent Negotiator Node of claim 27, where the AIN service is performed responsive to an Internet response message received in response to the Internet request message.

29. The Intelligent Negotiator Node of claim 20, where the INN provides a plurality of AIN services for the packet-based telephone subscriber, and further including the application server determining an order for providing the plurality of AIN services for the packet-based telephone subscriber.

30. The Intelligent Negotiator Node of claim 20, where the telecommunications network includes at least one service control point (SCP) communicatively coupled with the INN and the INN determines that the packet-based subscriber subscribes to a plurality of AIN services, wherein the application server performing the at least one advanced network service includes the application server employing an SCP communicatively coupled with the INN in the performing of an AIN service.

31. The Intelligent Negotiator Node of claim 20, where the packet-based communication protocol includes at least one of a Session Initiation Protocol, a Parlay message , an Internet Protocol, a Hypertext Transfer Protocol, a File Transfer Protocol, and an Extensible Markup Language protocol.

32. An Intelligent Negotiator Node (INN) of a telecommunications network that is capable of providing an Advanced Intelligent Network (AIN) service using information from the Internet, comprising:
an application server having capabilities for providing an AIN service, and for determining that Internet information is desired for use in providing the AIN service;
a memory coupled with the application server for storing information regarding AIN services subscribed to by a plurality of packet-based telephone customers;
a translator coupled with the application server, the translator generating an Internet request message in an Hypertext Transfer Protocol to retrieve the desired Internet information from the Internet, and forwarding the Internet request message to the application server; where
the application server uses the Internet request message to retrieve the desired information from the Internet, for use in providing the AIN service.

33. The Intelligent Negotiator Node of claim 32, where the telephone subscriber is a packet-based telephone subscriber.

34. The Intelligent Negotiator Node of claim 32, where the telephone subscriber is a Public Switched Telephone Network telephone subscriber.

35. A telecommunications system for providing an Advanced Intelligent Network (AIN) service to a packet-based telephone subscriber, comprising:
a packet-based telephone subscriber terminal for use by the packet-based telephone subscriber;
a softswitch for providing packet-based telephone service to the packet-based telephone subscriber terminal, and determining whether a packet-based telephone subscriber subscribes to an AIN service; and
an Intelligent Negotiator Node (INN) communicatively coupled with the softswitch, including
an application server capable of receiving a service request message in a packet-based communication protocol, and of providing an AIN service responsive to the service request message, the providing including generating at least one service response message in response to the AIN service being performed,
a translator, coupled with the application server, for extracting information from the service request message for use by the application server in providing the AIN service, and for operating with the application server in generating the service response message by converting resultant information from the performing of the AIN service to a packet-based communication protocol, and
a memory coupled with the application server for storing information regarding AIN services subscribed to by a plurality of packet-based telephone customers.

36. The telecommunications system of claim 35, further comprising a tandem switching point communicatively coupled with the softswitch, that receives a telephone call from the softswitch that is routed responsive to a performed AIN service for the packet-based telephone subscriber provided by the INN.

37. The telecommunications system of claim 35, further comprising a packet-based unified messaging server communicatively coupled with the INN allowing a telephone subscriber's e-mail messages to be converted to an audible format and read to the packet-based telephone subscriber, where the performing of the AIN service includes accessing the unified messaging server via the packet-based network.

38. The telecommunications system of claim 35, further comprising a packet-based intelligent peripheral that may be used for providing services to the packet-based telephone subscriber including creating packet-based telephone calls, playing announcements, performing text-to-speech conversion and voice recognition, collecting at least one of voice and telephone keypad digits, where the performing of the AIN service includes accessing the intelligent peripheral via the packet-based network.

39. A storage media for use in providing an Advanced Intelligent Network (AIN) service for a packet-based telephone subscriber using an Intelligent Negotiator Node (INN), the INN capable of communicating using a packet-based communication protocol, the storage media comprising:
a first memory portion programmed for receiving a service request message at the INN including information in a packet-based protocol, the information including an identification of a packet-based telephone subscriber;
a second memory portion programmed for determining at the INN the AIN service subscribed to by the packet-based telephone subscriber; and
a third memory portion programmed for performing at the INN the AIN service subscribed to by the packet-based telephone subscriber.

40. A storage media for use in providing an Advanced Intelligent Network (AIN) service for a telephone subscriber at an Intelligent Negotiator Node (INN) using information from the Internet, the storage media comprising:
a first memory portion programmed for determining that Internet information is desired at the INN;
a second memory portion programmed for translating a request for desired information into an Internet request message at the INN; and
a third memory portion programmed for performing the AIN service at the INN using information retrieved from an Internet response message received from the Internet responsive to the Internet request message.
